(19) United States
(12) Patent Application Publication
(10) Pub. No.: US 2020/0372750 A1
(43) Pub. Date: Nov. 26, 2020

(54) GAMING SYSTEM

(71) Applicant: TCS John Huxley Europe Limited, Stoke-On-Trent (GB)

(72) Inventors: Andrew Michael Saunders, London (GB); Nicholas Richard Baker French, Stoke-On-Trent (GB)

(21) Appl. No.: 16/962,380

(22) PCT Filed: Jan. 25, 2019
(86) PCT No.: PCT/GB2019/050212

§ 371 Date: Jul. 15, 2020

(30) Foreign Application Priority Data
Feb. 2, 2018 (GB) 1801719.4

(51) Int. Cl. G07F 17/32; G06F 7/58

(52) U.S. Cl. CPC G07F 17/3213; G07F 17/3288; G06F 7/588; G07F 17/3269; G07F 17/3272

(57) ABSTRACT

A gaining system is provided to maximise the number of betting opportunities in a set period. The gaming system comprises, at least two physical random number generators, each having an operative period of adjustable start time, wherein during the operative period a random number is generated, the operative period comprising a betting period; a gaining terminal, arranged to provide a betting interface; a memory unit in digital communication with the gaming terminal; and a control unit, arranged to control the gaming terminal, the memory unit and each of the physical random number generators; the betting interface comprising, an input portion accepting input from a user, the input comprising betting information during a betting period; and a selection of one of the at least two random number generators; wherein the betting interface further comprises an output portion providing output information to a user; the memory unit being arranged to store previous betting information input from a user into the input portion; wherein the and each subsequent start time of the operative period is controlled by way of the control unit, each operative period start time being staggered according to a time interval. The aim of the gaining system of the present invention is to provide the maximum number of betting opportunities in a given time period, wherein the number of opportunities can be customised according to the specific gambling regulations of the region, wherein the maximum number of betting opportunities per time period can be adjusted in order to accommodate any changes that are subsequently made to gambling regulations. Maximising the number of betting opportunities preferably enhances the consumer experience

### FIELD OF THE INVENTION

The present invention relates to electronic gaming systems, particularly to synchronous electronic gaming systems for use in casinos.

### BACKGROUND TO THE INVENTION

Gambling laws, rules and regulations in many regions around the world prevent excessive betting, particularly on physical gambling opportunities such as roulette wheels. Such regulations typically limit the number of betting opportunities in a given time period.

Currently available sources of gambling opportunities include gaming systems within a casino environment, such as roulette for example, wherein some form of physical random number generator is used to obtain at least one win condition. Such games generally include an operator, or a dealer, the role of whom is often to control the pace of a particular game and to maximise the number of betting opportunities in a given time period according to local gambling regulations. An increased number of betting opportunities is intended to improve the consumer experience, therefore enhancing fun and alleviating boredom.

While it is possible to train said operators or dealers to reduce the length of time spent during a particular gambling opportunity, and therefore increase the number of gambling opportunities per given time period, these human-driven systems can be inherently incapable of maximising the number of gambling opportunities per given time period to the full potential.

Gaming systems in a casino environment increasingly include some form of automated feature, often for the purpose of improved efficiency and removal of human error. These automations may be in the sorting of casino chips and in data tracking, among others. Such automations and data tracking methods can be used to identify bottlenecks in a gaming system and may be used to train and optimise said systems to reduce the time spent during the length of a betting opportunity. However, these systems still do not completely maximise the number of betting opportunities per given time period.

It is therefore desirable to maximise the number of possible betting opportunities in one hour, customised according to the specific gambling regulations of the region, wherein the maximum number of betting opportunities per hour can be adjusted in order to accommodate any changes that are subsequently made to gambling regulations. Maximising the number of betting opportunities preferably enhances the consumer experience.

### SUMMARY OF THE INVENTION

In accordance with a first aspect of the present invention, there is provided a gaming system comprising, at least two physical random number generators, each having an operative period of adjustable start time, wherein during the operative period a random number is generated, the operative period comprising a betting period; a gaming terminal, arranged to provide a betting interface; a memory unit in digital communication with the gaming terminal; and a control unit, arranged to control the gaming terminal, the memory unit and each of the physical random number generators; the betting interface comprising, an input portion accepting input from a user, the input comprising: betting information during a betting period; and a selection of one of the at least two random number generators; wherein the betting interface further comprises an output portion providing output information to a user; the memory unit being arranged to store previous betting information input from a user into the input portion; wherein the and each subsequent start time of the operative period is controlled by way of the control unit, each operative period start time being staggered according to a time interval.

Preferably the time interval is predetermined. Preferably the time interval is adjustable.

The random number generators of the present invention are physical, with the random number generation constituting a live event during a perceivable operative period—as opposed to being software-derived, wherein the generation of a random number may be considered to be instantaneous. The operative period of each random number generator, which may optionally be a roulette wheel, has an adjustable start time. The adjustable start time permits for operative periods of each random number generator to occur sequentially. In so doing, the present invention provides the feature of synchronising the operative periods of random number generators, such as roulette wheels. As such, the available betting periods of each random number generator are staggered, such that they occur within a minimal interval of one another. This allows for the maximum number of operative periods of each random number generator per hour, maximising hourly betting opportunities without permitting concurrent betting on multiple tables.

The present invention therefore preferably addresses the technical challenges of synchronicity of physical random number generator systems. Such challenges include overcoming unnecessary intervals of time in-between betting periods, during which there are no betting opportunities provided to a player. Reductions in said intervals is preferable in order to improve player satisfaction, and adequate synchronicity of betting periods provided by the present invention preferably overcomes this challenge. This challenge of synchronicity is made significantly more difficult as the number of simultaneously operating physical random generators increases. The act of synchronising physical random number generators by the present invention is not simply the act of synchronising operative periods according to time. During an operative period of a physical random number generator, such as a roulette wheel, there are a number of (in many cases randomised or variable) factors affecting the duration of an operative period, a betting period and/or an exit period. These factors may, using a roulette wheel as one suitable example, include the randomised and/or variable launch speed of a roulette ball circling the ball track of the roulette wheel; the randomised and/or variable direction of the ball circling the ball track; any randomised and/or variable spin placed on the roulette ball during or after launch, and the speed and direction thereof; the time taken for said ball to leave the ball track; the trajectory of the ball along the lower ball track or apron toward the pockets contained within the spindle, which may include any number of random collisions with one or more ball deflectors; the rate of drop of the ball from the ball track or lower ball track toward the pockets of the spindle; the randomised and/or variable rate of spin of the spindle; any collisions of the ball with any number of frets, or pocket separators; and any randomised and/or variable time periods, such as an exit period, for the ball to be recovered, for winning wagers to be rewarded, and for the operative period of the physical random number generator to begin again. As a result of a combination of these random and/or variable factors, the duration of an operative period and/or a betting period cannot be predetermined and as such cannot currently be easily synchronised with other similarly unpredictable betting periods. Randomisation and/or variability in such factors is, however, important in order to reduce predictability of an outcome and thereby reducing cheating. Synchronisation of certain of said randomised or variable factors may be combined in such a way as to reduce predictability. For example in embodiments comprising two roulette wheels, the speed of a first wheel may be run fast/slow compared to the speed of a second wheel with which the first wheel is to be synchronised in any one game. Synchronisation in the present invention is preferably achieved by staggering operative period start times according to a time interval. Preferably said time interval may be controlled or predetermined according the randomised and/or variable factors of the two or more physical random number generators, such that the operative period start time of one physical random number generator coincides with an end time of the time interval. In the context of the present invention, the term “variable” will be understood to mean settable to a predetermined value, as opposed to “randomised”. In examples wherein randomisation is determined by a computer processor, said randomisation may involve pseudorandomisation.

In combination with the aforementioned challenges, the synchronisation of betting periods of random number generators may be further exacerbated when a specific number of betting opportunities are intended to be provided in a given time period (such as 60 betting opportunities in an hour) as determined by local and regional gambling regulations. A randomised duration of all or part of an operative period of a physical random number generator, in-part governed by any of the many randomised factors discussed above, means that this does not constitute a discreetly definable frequency of betting opportunities, such as one per minute. Instead, this maximum number of betting opportunities must be obtained through appropriate synchronisation of operative periods of multiple physical random number generators, adapting for the varying (and often randomised) speeds of ball drop/wheel speed, among other factors previously discussed. The synchronisation provided in the present invention therefore addresses a technical challenge, and not one of merely predefining a frequency of betting periods of two or more physical random number in a given time.

Preferably the length of the betting period is controlled by way of the control unit, the control unit operating the at least two physical random number generators such that no two betting periods on the gaming terminal overlap. In the context of the present invention, the term “gaming” will be understood by the skilled addressee to mean “gambling”.

The gaming terminal comprises a betting interface which accepts user input, preferably in the form of touching a touch-sensitive screen, to define a selection of random number generator on which to bet, and associated betting information. Input betting information may comprise a number, a group and/or category of numbers, along with a betting currency value. The gaming terminal also comprises an output which preferably provides feedback to the user based on the result of a random number generator and preferably includes a jackpot sequence, should the user successfully predict the outcome of a random number generator. The output preferably further comprises a live, real-time, visual display of the chosen random number generator, and more preferably also includes a live visual display of the one or more other random number generators. In instances where there are more than one random number generators displayed visually on the gaming terminal at one time, the gaming terminal preferably further comprises a visual indication of which random number generator the user has selected as active. Preferably, the user may swap between random number generators as they choose, and most preferably the user may only bet on one random number generator at any one time. As such the betting periods of the random number generators are preferably to be staggered. Most preferably the betting periods on a single gaming terminal do not to overlap.

In most countries around the world, depending upon the type of game being played, gambling regulations restrict the number of bets per hour (to, for instance, 50 to 55 bets per hour), and in many cases prohibit concurrent bets on multiple active tables. As such, live events on which betting can take place, such as, for example, the spin of a roulette wheel, are only permitted to occur a specific maximum number of times in one hour. Using the present invention, the synchronisation of live events occurring one after the other enables the user to minimise time spent waiting for the same source of betting opportunities to once again be made available for betting, or time spent moving to another source of betting opportunities and waiting for said source to be made available for betting. As such the user is allowed to minimise the waiting time, and maximise the number of betting opportunities according to local gambling regulations.

Preferably, the betting interface may be used to access previous betting information from the memory unit, preferably for the purpose of re-inputting the previous betting information during a subsequent betting period.

Most preferably, the gaming terminal permits the input of betting information for only one random number generator at a time.

It is currently not possible on most live casino games to duplicate a previously-made bet on a future event, such as, for example, the same physical random number generator. In order to maximise the number of betting opportunities possible in a given time period, it would therefore be preferable for a user to duplicate previously submitted betting information in order to avoid the time required to re-enter the same information time and time again. A more preferable feature would be to allow a user to duplicate previously made bets across different physical random number generators, when said physical random number generators become available for betting, and so that no concurrent betting takes place. In duplicating bets across different physical, the user may be allowed to further minimise time spent re-entering the same betting information as has already been entered.

Preferably a user is provided with information that includes an indication of when a random number generator is available for betting. Together with information relating to which table the user is currently playing at, this information is preferably used to easily permit switching between tables as and when they become available. Combined with the preferable feature of having a user be able to duplicate previously submitted betting information across different tables, the user is therefore allowed to minimise the time spent idle at a gaming terminal.

According to preferable embodiments, the start time of any of: the operative period; the betting period; may be adjusted. In most preferable embodiments the length of any of: the operative period; the betting period; may be adjusted. The operative period preferably further comprises an exit period of adjustable start time and length. Preferably, the operative period further comprises a ‘no more bets’ period of adjustable start time and length.

A predetermined time interval is preferably used to separate the start time of the betting periods of the random number generators from one another. The predetermined time interval is preferably the minimum amount of time taken from the start time of a betting period to the end of said betting period. The predetermined time interval therefore serves as a separation between betting events such that there are no concurrent bets taking place by a single user on different random number generators. At least one of the operative period and the betting period of a random number generator may preferably be adjusted in order to account for lag by another random number generator. As such the length of time taken between betting periods is preferably minimised and the number of sequential betting opportunities per hour is preferably maximised. Preferably at least one of the operative period and the betting period may be extended, or reduced, in order to ensure compliance with local gambling regulations. Should it appear that local gambling regulations will be contravened according to the current rate of provision of betting opportunities over time, the length of the operative period and the betting period may be altered to account for this. Similarly, the length of said periods may be altered in order to increase the number of betting opportunities over time.

The gaming terminal preferably provides a view of and access to all of the betting options available to a user. The output portion of the betting interface preferably outputs a view of at least one of the random number generators. The gaming system preferably further comprises at least one camera providing a view of at least one of the random number generators to the gaming terminal to be output to a user.

The gaming terminal is enabled to provide the user with all of the betting options available for a particular random number generator. These options are preferably provided by way of the output portion which, in most preferable embodiments, also includes a visual display of at least one of the random number generators. In embodiments wherein the output portion comprises a visual display of at least one of the random number generators, the visual display is preferably obtained using at least one camera.

In most preferable embodiments, the gaming system comprises a plurality of gaming terminals. The gaming terminals are preferably each enabled to access all of the available random number generators of the gaming system, with each being controlled by the control unit in order to unify the output portion of each of the gaming terminals. The gaming terminals preferably have access to the same information as each other at all times, with none of the gaming terminals provided with any advantage, technical or otherwise, over the others.

Preferably the gaming system further comprises at least one camera providing a view of at least one of the random number generators to the gaming terminal to be output to a user. More preferably, the view provided to the gaming terminal to be output to a user is real-time video. Still more preferably, said gaming terminal is remote to said at least one of the random number generators.

The at least two random number generators are preferably selected from the range: roulette wheel; dice shaker; dice spinner; number wheel; money wheel; sic bo; cards; electronic card shoe; manual card shoe; bingo machine; lottery machine. A number of different random number generators are currently available, such as those hereinbefore described. The system of the present invention is preferably forward compatible with future iterations of random number generators where these may be applicable to the present system.

### DETAILED DESCRIPTION

Specific embodiments will now be described by way of example only, and with reference to the accompanying drawings, in which:

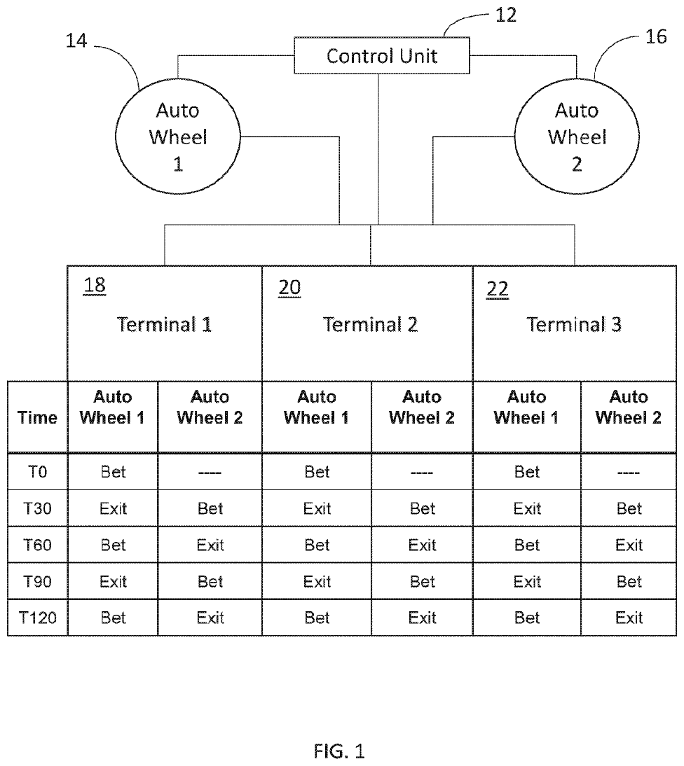

FIG. 1 is a schematic representation of the components of an example embodiment of a system according to the present invention;

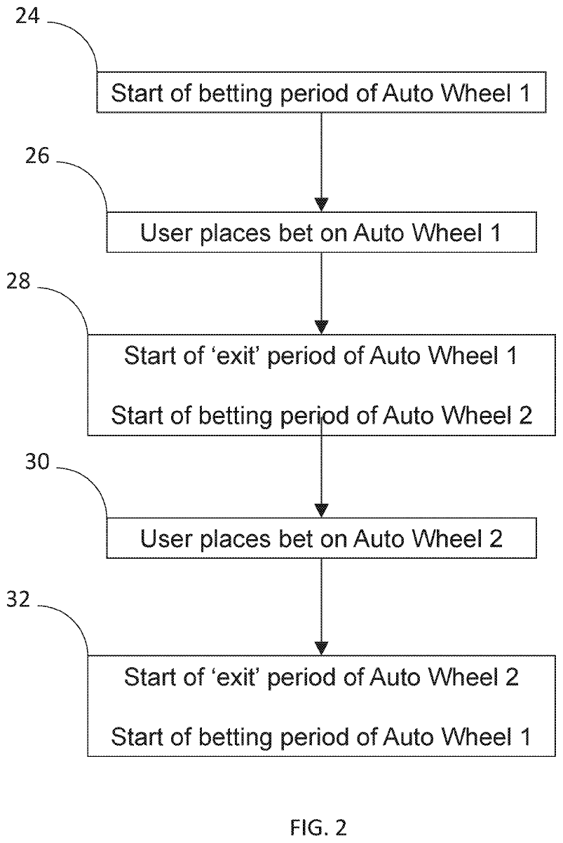

FIG. 2 is a flow diagram representing the sequence of events taking place at a single gaming terminal of the system according to FIG. 1; and

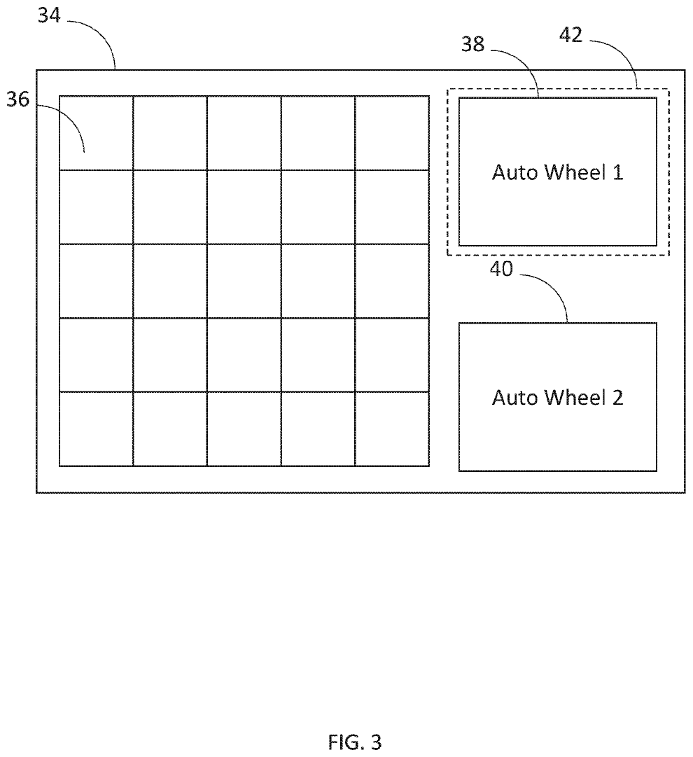

FIG. 3 is a perspective view of an example input portion and output portion of a gaming terminal according to the embodiment shown in FIG. 1.

With reference to FIG. 1, there is provided a schematic representation of an example embodiment of a gaming system 10 according to the present invention. A control unit 12 taking the form of a computer connected to a server, is in digital communication with a first physical random number generator 14, a second physical random number generator 16, a first gaming terminal 18, a second gaming terminal 20 and a third gaming terminal 22. The first physical random number generator 14 and the second physical random number generator 16 take the form of a first and second automated roulette wheel 14, 16 respectively, each having an operative period.

The first automated roulette wheel 14 and the second automated roulette wheel 16 comprise a bowl having a plurality of pockets defining betting options. The betting options include a plurality of numbers and two colours, wherein each pocket comprises a single number and a single colour.

The first, second and third gaming terminals 18, 20, 22 each comprise a betting interface comprising an input portion taking the form of a touch-sensitive screen. The touch-sensitive screen is also arranged to provide an output portion, in the form of an interactive display of all of the available betting options for the first and second automated roulette wheels 14, 16. The touch-sensitive screens of the first, second and third gaming terminals 18, 20, 22 are further arranged to accept an input from a user wherein the input comprises a selection of betting information from the available betting options and a selection of either the first automated roulette wheel 14 or the second automated roulette wheel 16 on which to bet. Betting information may be input to the input portion by a user on a choice of the first or second automated roulette wheels, only during the betting period of said chosen wheel.

The first and second automated roulette wheels 14, 16 comprise a rotating mechanism, arranged to rotate the bowl of the first and second automated roulette wheels 14, 16 for a predetermined length of time and at a predetermined rotational speed. The first automated roulette wheel 14 and the second automated roulette wheel 16 have an operative period of adjustable start time, the start time being adjustable by the control unit 12. During the operative period the rotating mechanisms of the first automated roulette wheel 14 and the second automated roulette wheel 16 are activated by the control unit 12. A ball launcher is arranged to launch a roulette wheel ball around the circumference of the bowl during rotation, wherein the ball launcher is arranged to determine the velocity at which the ball is launched. The launch of a ball from the ball launcher is controlled by the control unit 12.

Following launch, the ball is arranged to traverse the inside surface of said bowl, starting at a most vertical position, until a reduction in momentum causes the ball to reduce vertical positioning in the bowl. As momentum of the ball and the vertical positioning of the ball within the bowl reduces, the ball sequentially passes a “no more bets” threshold and enters a pocket of the roulette wheel. The pocket in which the ball lands, determines the random number generated and therefore the win condition for the particular operative period of the first and second automated roulette wheels 14, 16. In the embodiment described, the ball is retrieved from the pocket and returned to the ball launcher to be launched during the next operative period. In the embodiment shown, the passing of the ball across a “no more bets” threshold signals the end of the betting period for the particular automated roulette wheel, and the beginning of a “no more bets” period for said wheel, which is comprised within an exit period. Following the determination of a win condition for a particular wheel, wherein input of betting information to the input portion which matches the win condition results in a win, the exit period is ceased, signalling the end of the operative period for said wheel. In the embodiment shown, betting information cannot be entered for a particular automated roulette wheel during the exit period, comprising a “no more bets” period and the determination of a win condition, of the operative period of said wheel.

As can be seen in FIG. 2, which shows a flow diagram representing the sequence of events taking place at a single gaming terminal of the system according to FIG. 1, the control unit 12 begins the operative period of the first automated roulette wheel 14 such that the betting period of said wheel is commenced 24. During said betting period, a user is able to input betting information for the first automated roulette wheel 26. Upon the start of a “no more bets” period of the exit period, the operative period of the second automated roulette wheel 16 is commenced 28. While the input of further betting information for the first automated roulette wheel is prevented, the input of betting information for the second automated roulette wheel is permitted 30. This input of betting information for the second automated roulette wheel 30 might be the same betting information inputted previously during the betting period of the first automated roulette wheel 26. Following the commencement of the “no more bets” period of the second automated roulette wheel 16, the betting period of the first automated roulette wheel may commence 32.

In the embodiment shown in FIG. 1, the control unit 12 is arranged to initiate the operative period of one of the first automated roulette wheel 14 or the second automated roulette wheel 16 such that the betting period of said wheel does not overlap with the betting period of the other wheel. This is performed by the control unit 12 by causing the start-time of the operative period of one wheel and the start-time of the operative period of the other wheel to be staggered. The staggering of operative periods in the embodiment shown preferably prevents the overlap of betting periods from different automated roulette wheels and as such does not permit simultaneous betting on a plurality of automated roulette wheels. This enables the embodiments shown to adhere to region-specific gambling regulations. The staggering of operative periods also enables the control unit 12 to minimise the length of time between betting periods and therefore allows a user to maximise the number of betting opportunities in a given time period.

In the embodiment shown, each of the first gaming terminal 18, the second gaming terminal 20 and the third gaming terminal 22 comprises a memory enabled to store previously inputted betting information. Said gaming terminals further comprise an input option for the user to access the previously submitted betting information from the memory, in order to reinput previously inputted betting information during a subsequent betting period. In the embodiment shown, the ability to reinput previously inputted betting information during a subsequent betting period reduces the time taken to reinput most preferable betting information and therefore helps to maximise the number of betting opportunities in a given time period.

In the embodiment shown, a time interval between the operative period of the first automated roulette wheel 14 and that of the second automated roulette wheel 16, may be adjusted in order to reduce the number of betting opportunities in a given time period. This may be used in particular scenarios wherein the maximum number of betting opportunities in a given time period is projected to exceed those permitted by local gambling regulations.

As can be seen in FIG. 1, the control unit 12 is arranged to initiate the operative period of the first automated roulette wheel 14, which carries out a random number generation within 30 seconds. The control unit 12 is arranged to then initiate the operative period of the second automated roulette wheel 16, which carries out a subsequent random number generation within 30 seconds. Thus the initiation of random number generation is staggered by a predetermined period of 30 seconds for each wheel.

In the embodiment shown, the control unit 12 comprises a computer connected to a server. The server enables network communication between all parts in the gaming system of the present invention. Embodiments will be appreciated wherein the server is in wired communication with one or more constituent elements of the system. Additional embodiments will be appreciated wherein the server is in wireless communication with one or more constituent elements of the system. Further embodiments will be appreciated wherein the control unit does not comprise a server.

As can be seen in FIG. 3, which shows the input and output portion of a gaming terminal 18, 20, 22 of FIG. 1, the touch-sensitive screen 34 provides a visual display of the betting options 36 to a user. The gaming terminal 18, 20, 22 also provides a visual display of both the first automated roulette wheel 38 and the second automated roulette wheel 40. The user is provided with the information on which of the first automated roulette wheel 14 and the second automated roulette wheel 16 is currently active by way of the highlight 42 around the visual display 38 of the first automated roulette wheel 14. The highlight 42 remains around the visual display 38 of the first automated roulette wheel 14 until the user opts to select the visual display 40 of the second automated roulette wheel 16.

It will be appreciated that the above described embodiments are given by way of example only and that various modifications thereto may be made without departing from the scope of the invention as defined in the appended claims.

1. A gaming system comprising:
at least two physical random number generators,
each having an operative period of adjustable start time,
wherein during the operative period a random number is generated,
the operative period comprising a betting period;
a gaming terminal,
arranged to provide a betting interface;
a memory unit in digital communication with the gaming terminal; and
a control unit,
arranged to control the gaming terminal,
the memory unit and
each of the at least two physical random number generators;
the betting interface comprising,
an input portion accepting input from a user, the input comprising betting information during the betting period; and
a selection of one of the at least two random number generators, wherein the betting interface further comprises an output portion providing output information to the user;
the memory unit being arranged to store previous betting information input from the user into the input portion;
wherein subsequent start time of the operative period is controlled by way of the control unit, each operative period start time being staggered according to a time interval.

2. The gaming system of claim 1, wherein the time interval is predetermined.

3. The gaming system of claim 1, wherein a length of the betting period is controlled by way of the control unit, the control unit operating the at least two physical random number generators such that no two betting periods on the gaming terminal overlap.

4. The gaming system of claim 1, wherein the betting interface may be used to access the previous betting information from the memory unit for the purpose of re-inputting the previous betting information during a subsequent betting period.

5. The gaming system of claim 1, wherein the gaming terminal permits the input of betting information for only one random number generator at a time.

6. The gaming system of claim 1, wherein the start time of any of
the operative period or
the betting period
is adjustable.

7. The gaming system of claim 1, wherein the length of any of
the operative period or
the betting period
is adjustable.

8. The gaming system of claim 1, wherein the operative period further comprises an exit period of adjustable start time and length.

9. The gaming system of claim 1, wherein the operative period further comprises a ‘no more bets’ period of adjustable start time and length.

10. The gaming system of claim 1, wherein the gaming terminal provides a view of and access to all of the betting options available to the user.

11. The gaming system of claim 1, wherein the output portion of the betting interface outputs a view of at least one of the physical random number generators.

12. The gaming system of claim 1, further comprising at least one camera providing a view of at least one of the physical random number generators to the gaming terminal to be output to the user.

13. The gaming system of claim 12, wherein the view provided to the gaming terminal to be output to the user is real-time video.

14. The gaming system of claim 12, wherein the gaming terminal is remote to the at least one of the physical random number generators.

15. The gaming system of claim 1, wherein the gaming system comprises a plurality of gaming terminals.

16. The gaming system of claim 1, wherein the at least two physical random number generators are selected from a group consisting of: a roulette wheel; a dice shaker; a dice spinner; a number wheel; a money wheel; sic bo; cards; an electronic card shoe; a manual card shoe; a bingo machine; and a lottery machine.
